(19) United States
(12) Patent Application Publication
(10) Pub. No.: US 2015/0286018 A1
(43) Pub. Date: Oct. 8, 2015

(54) COST-EFFECTIVE OPTICAL COUPLING MODULE

(71) Applicant: Electronics and Telecommunications Research Institute, Daejeon (KR)

(72) Inventors: EUN GU LEE, Daejeon (KR); JYUNG CHAN LEE, Daejeon (KR); SIL GU MUN, Daejeon (KR); SANG SOO LEE, Daejeon (KR)

(21) Appl. No.: 14/628,445

(22) Filed: Feb. 23, 2015

(30) Foreign Application Priority Data
Apr. 8, 2014 (KR) 10-2014-0041988

(51) Int. Cl. G02B 6/42

(52) U.S. Cl. CPC G02B 6/4228

(57) ABSTRACT

A cost-effective optical coupling module for achieving an optical coupling by providing a predetermined space between an optical element and an optical waveguide without an additional lens is provided. The cost-effective optical coupling module includes an optical element configured to output or receive an optical signal, a substrate configured to allow the optical element to be fixed to an upper surface of one side thereof, an optical waveguide disposed above the optical element and coupled to the optical element, and spacers protruding at both sides of the substrate to maintain an interval between the optical waveguide and the optical element.

### CROSS-REFERENCE TO RELATED APPLICATION

This application claims the benefit under 35 U.S.C. §119(a) of Korean Patent Application No. 10-2014-0041988, filed on Apr. 8, 2014, the entire disclosure of which is incorporated herein by reference for all purposes.

### BACKGROUND

1. Field

The following description relates to technology for a cost-effective optical coupling module, and more particularly, to a cost-effective optical coupling module for achieving an optical coupling by providing a predetermined space between an optical element and an optical waveguide without an additional lens.

2. Description of the Related Art

In general, a wavelength division multiplexing (WDM) is a technology for multiplexing optical signals of different wavelengths to be sent over a single optical fiber, in which the capacity of transmission is increased by the number of wavelengths.

In order to apply the WDM technology to an optical communication including a subscriber network or data center, the implementation of the WDM needs to be cost-effective due to the characteristics of the corresponding network, so that an array of light sources is used. However, the coupling of the array of light sources is more complicated than the coupling of a single light source, which increases the manufacturing cost. Not only for the WDM, the technology for coupling multichannel light sources to multichannel optical waveguides at a low cost provides a cost advantage in using an array of light sources.

FIG. 1 illustrates a prior art for coupling an array of light sources to an array of waveguides, which is disclosed in U.S. Patent Publication No. US20040264884 as ‘Compact package design for vertical cavity surface emitting laser array to optical fiber cable connection’ in which an array lens is used. When an array of lenses is used for optical coupling as shown in FIG. 1, a short pitch between lenses makes it difficult to manufacture the array lens, which increases the manufacturing cost. In general, an array of waveguides represents an array of fibers, and in this case, a pitch between waveguides is 250 um or 127 um, and a pitch between array lenses needs to be equal to the pitch between waveguides. The commercial array lenses having such a pitch are costly nowadays, thereby causing the manufacturing cost to be increased. In addition, the additional use of an array lens increases the number of processes, so that the production per unit time may be reduced.

A long pitch between lenses of an array provides a cost advantage in manufacturing the array lenses, but accordingly, a pitch between light sources of an array also needs to be long, which causes the number of light sources produced in a single wafer to be reduced, thereby increasing the manufacturing cost. In addition, a pitch between array waveguides for optical coupling also needs to be long, so that the commercial product cannot be used, thereby increasing the manufacturing cost and leading to a large space occupied.

FIGS. 2 and 3 illustrate another prior art disclosed in U.S. Patent Publication No. US20060162104 as ‘High speed optical sub-assembly with ceramic carrier’, which is similar to the present disclosure in the concept of placing a space above a light source 2, but is different in that the space above the light source is adjusted by using intermediate layers 20, 22, and 24, and a high speed signal line is provided between the intermediate layers 20, 22, and 24, and that a lens 50 is positioned between a light source and an optical waveguide, and material is limited to ceramic.

Butt coupling is a method suggested to compensate for the limitation of cost incurred when the array lens is used. According to the Butt coupling shown in FIG. 4, in the case of measurement, light output from a light source 11 is introduced to a measurement optical waveguide 12 by passing through air, but in a packaged state, light output from the light source 11 is directly introduced to a packaged optical waveguide 13, so that the light experiences different refractive indices, thereby producing different characteristics of the light source in each case of the measurement and packaging.

FIG. 5 illustrates optical characteristics of a ridge type laser that varies with a distance of the Z axis. In this case, a beam divergence is great, so that even a small increase in the distance along the Z axis may lower the optical coupling efficiency. However, as for a VCSEL, a sufficient distance is ensured due to its small beam divergence, and a reflective on a surface of a resonator is great, thereby preventing the degradation of the optical coupling efficiency. When a resonator is formed using the difference in refractive index between a semiconductor surface and air, the degree of change in optical characteristics may be predicted, but it is still complicated to manufacture an optical product using the predicted result other than a measurement result. Further, when an anti-reflection (AR) or high-reflection (HR) coating is performed on a light output surface for a certain purpose, the characteristics of the coating is completely changed depending on the refractive index of a space in which light is output, thereby causing difficulty in even predicting the optical characteristics.

As described above, in order to manufacture a cost-effective light source to be used for an optical communication, such as a subscriber network or a data center, there are some requirements of low cost components constituting an optical transmission sub-assembly or optical reception sub-assembly, low cost package equipment being available for use, and a simple package process. However, the existing technologies have limitations in implementing the low cost light source.

### SUMMARY

The following description relates to an optical coupling module enabling a simple optical packaging and providing a cost reduction by only placing a predetermined space for optical coupling between an optical element and an optical waveguide so that the optical coupling between the optical element and the optical waveguide is achieved without disposing an expensive array lens between the optical element and the optical waveguide.

In one general aspect, a cost-effective optical coupling module includes an optical element, a substrate, an optical waveguide, and spacers. The optical element may be configured to output or receive an optical signal. The substrate may be configured to allow the optical element to be fixed to an upper surface of one side thereof. The optical waveguide may be disposed above the optical element and coupled to the optical element. The spacers may protrude at both sides of the substrate to maintain an interval between the optical waveguide and the optical element.

An electrical interface may be provided on an upper surface of the other side of the substrate.

A surface of the optical waveguide which faces the optical element may be treated with antireflection (AR) coating.

An end section of the optical waveguide which faces the optical element may be angled to one side.

The optical waveguide may be fixed to a support block so as to be easily bonded to the spacer.

The substrate may include a subsidiary substrate on which the optical element is mounted and a main substrate on which the subsidiary substrate and the spacer are mounted. A thermistor may be mounted on an upper surface of the substrate to be adjacent to the optical element, the thermistor having a height lower than a height of the optical element.

The substrate may be integrally formed with the spacer.

The main substrate may be integrally formed with the spacer.

The substrate may be an insulator including silicon or ceramic.

Other features and aspects will be apparent from the following detailed description, the drawings, and the claims.

### BRIEF DESCRIPTION OF THE DRAWINGS

FIGS. 1 to 5 are diagrams illustrating conventional optical coupling modules.

FIG. 6 is a cross sectional view showing a cost-effective optical coupling module in accordance with an embodiment of the present disclosure.

FIG. 7 is a perspective view illustrating a cost-effective optical coupling module in accordance with the present disclosure.

FIGS. 8 to 10 are perspective views showing various shapes of a spacer of FIG. 7.

FIGS. 11 and 12 are diagrams illustrating a coating layer formed on the surface of an optical waveguide with regard to FIG. 6.

FIGS. 13 and 14 are diagrams illustrating support blocks fixed to an optical waveguide of FIG. 14.

FIG. 15 is a cross sectional view showing a subsidiary substrate disposed with regard to FIG. 6.

FIG. 16 is a perspective view showing a subsidiary substrate disposed with regard to FIG. 7.

FIGS. 17 and 18 are cross sectional views illustrating a thermistor additionally mounted on a substrate.

FIGS. 19 and 20 are perspective views illustrating a substrate integrally formed with a spacer.

FIG. 21 is a cross sectional view showing a cost-effective optical coupling module in accordance with another embodiment of the present disclosure.

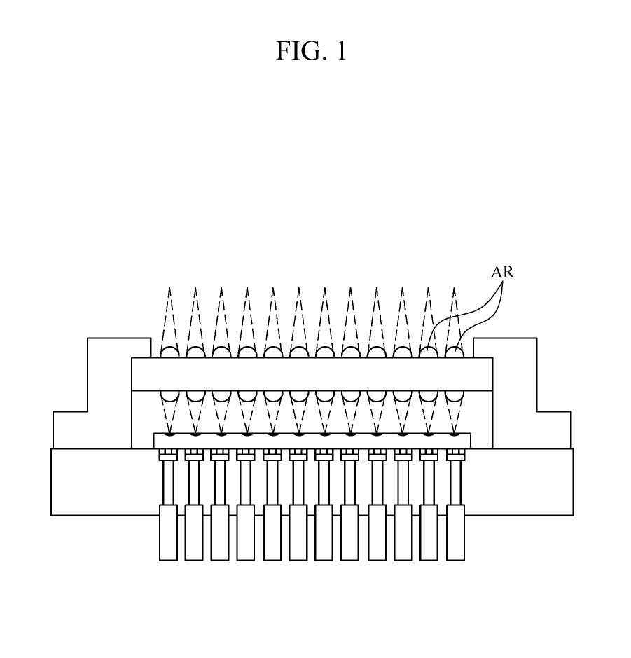

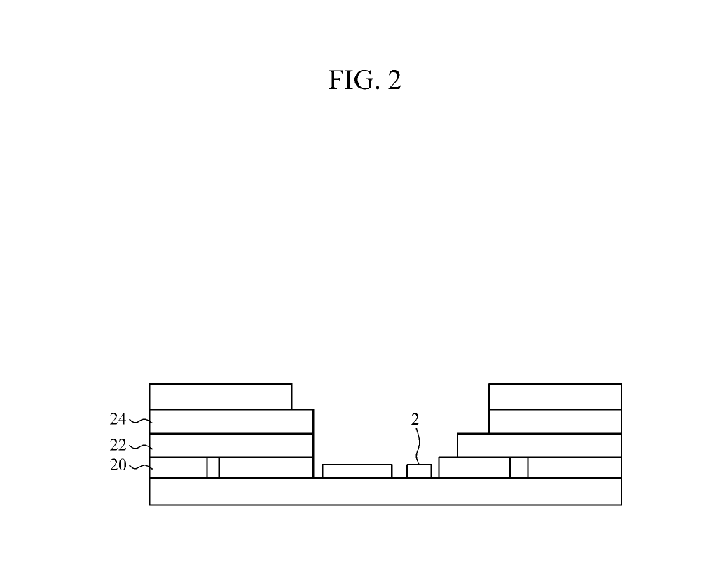

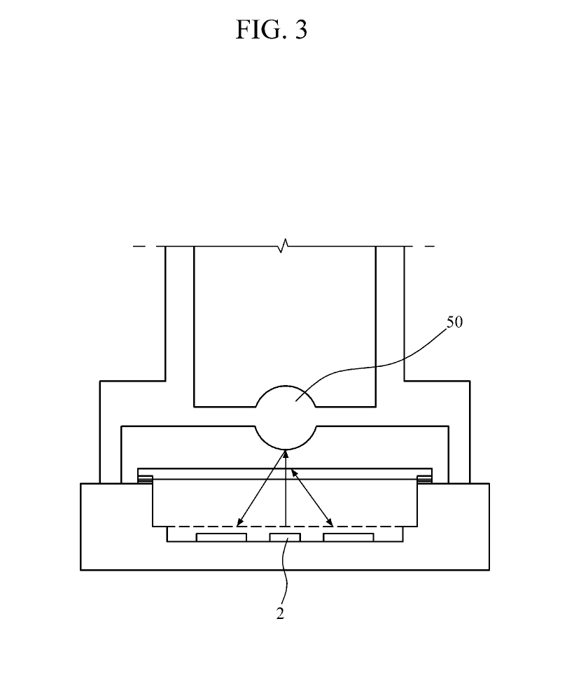

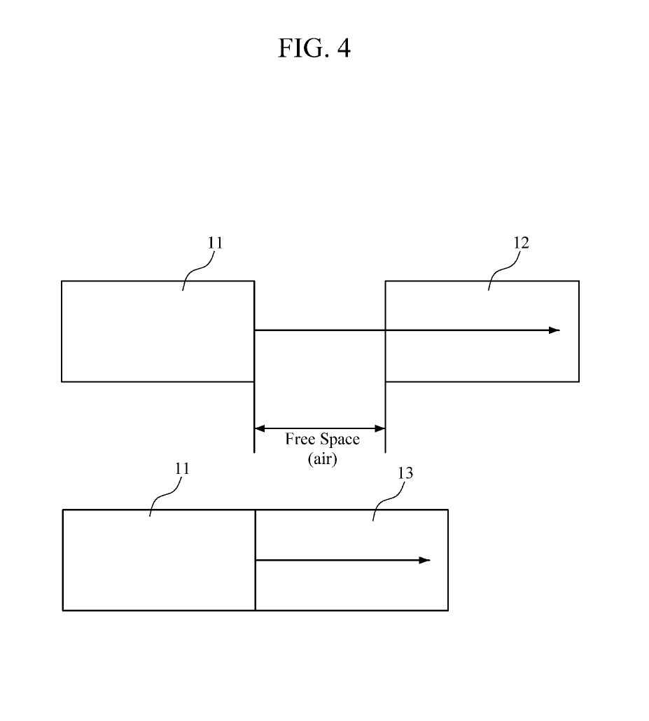

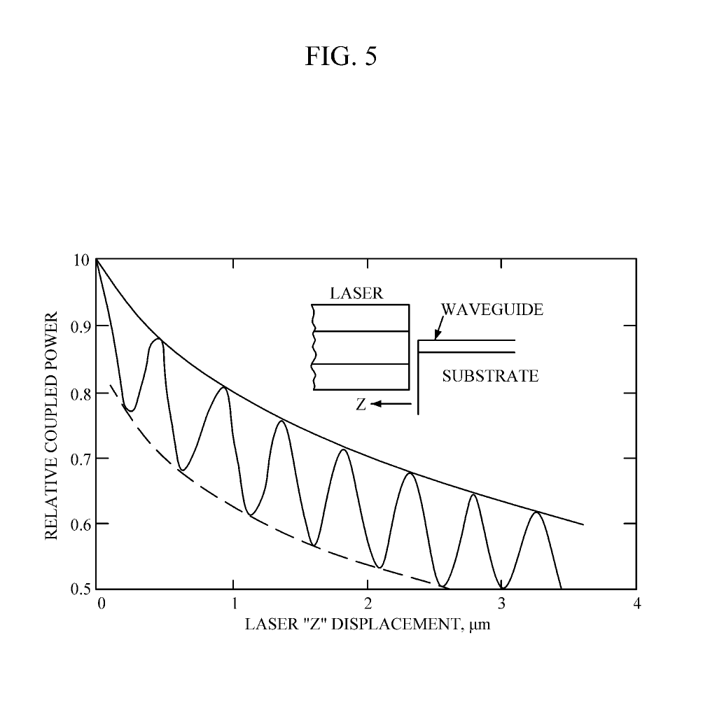

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. In addition, terms used herein are defined in consideration of functions in the present invention and may be changed according to the intentions of a user or an operator or conventional practice. Therefore, the definitions must be based on content throughout this disclosure.

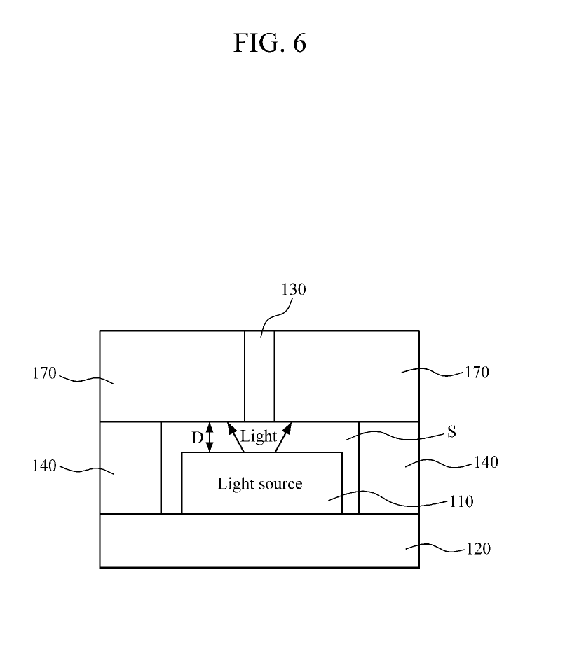

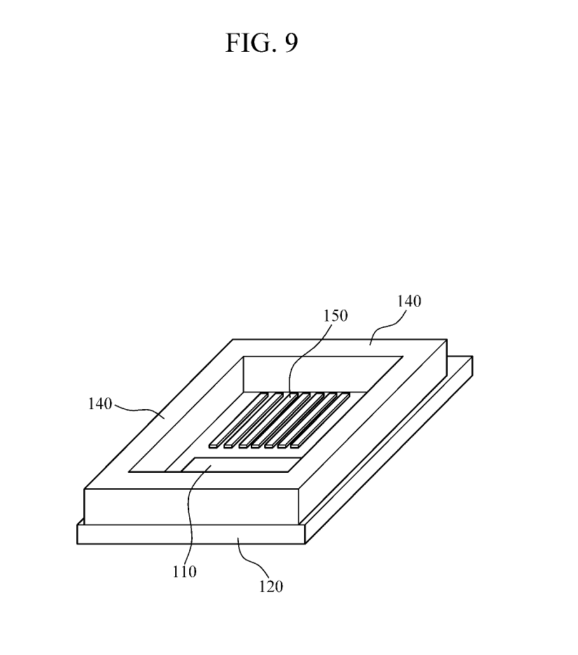

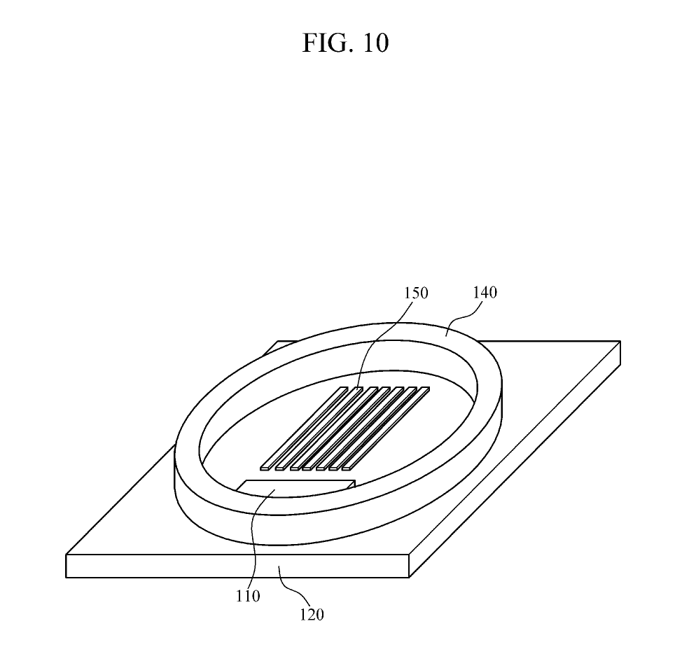

The present disclosure relates to a cost-effective optical coupling module capable of enabling optical coupling by providing a predetermined space between an optical element and an optical waveguide without using an additional lens. Embodiments of the present disclosure are illustrated with reference to FIGS. 6 to 21.

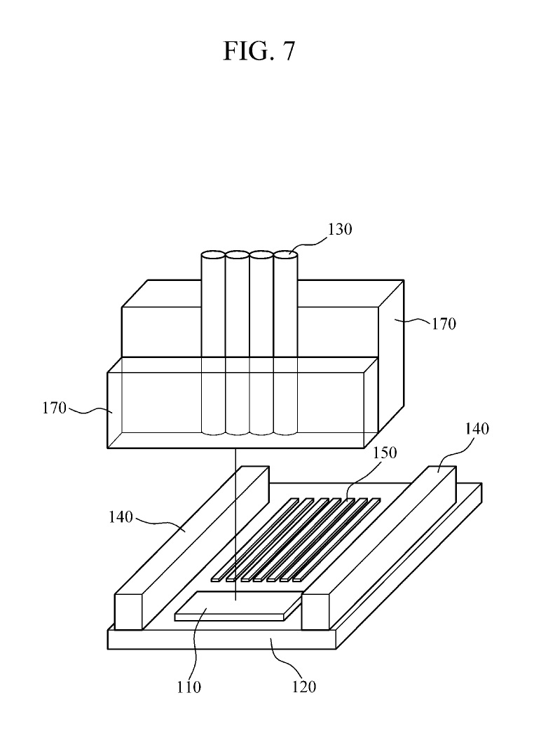

Referring to FIGS. 6 and 7, a cost-effective optical coupling module in accordance with an embodiment of the present disclosure includes an optical element 110, a substrate 120, an optical waveguide 130, and a spacer 140.

The present disclosure may be applied to reducing the cost of a single channel optical transmission sub-assembly. Hereinafter, the following description will be made in relation to a multichannel optical transmission sub-assembly as an example for the convenience of explanation.

The optical element 110 is configured to output or receive an optical signal, and may be provided using a light source or a light-receiving element.

When the optical element 110 is provided using a light source to output an optical signal, the light source may be a vertical-cavity surface-emitting laser (VCSEL) to transmit a laser used for optical communication or a VCSEL array (hereinafter, referred to as VCSEL). The light source implemented as a VCSEL may be implemented in a bottom emission type or a top emission type. According to the bottom emission type VCSEL, a pad to supply an electric current is provided in a direction opposite to a direction of light output, and according to the top emission type VCSEL, a pad to supply an electric current is provided in the same direction as a direction of light being output. As for the bottom emission type, an additional wiring is required to inject a current, so that a distance between the light source and the optical waveguide 130 is greater than that in the top emission type VCSEL.

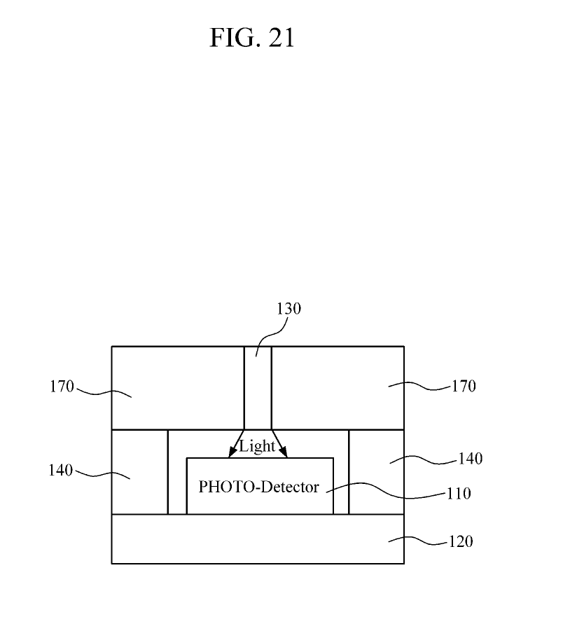

Meanwhile, the optical element 110 may be provided using a light-receiving element other than a light source. In this case, light propagates in a direction opposite to a direction shown in FIG. 6, in which light is directed from a light source to the optical waveguide 130, and an optical signal is transmitted from the optical waveguide 130 to the light-receiving element as shown in FIG. 21.

The substrate 120 is provided in the form of a plate and allows the optical element 110 to be fixed to an upper surface of one side thereof. The substrate 120 serves to fix the optical element 110, and an electrical interface may be formed on an upper surface of the other side of the substrate 120, to which the optical element 110 is not fixed. According to one example, the substrate 120 may be provided using a printed circuit board (PCB) or a flexible printed circuit board (FPCB) capable of providing an electrical interface 150. According to another example, the substrate 120 may be formed of a material having a superior thermal conductivity to effectively emit heat generated from the optical element 110.

The substrate 120 may be formed using aluminum nitride (AlN) capable of providing the electrical interface 150 and having a superior thermal conductivity. Alternatively, the substrate 120 may be formed of various types of insulating materials that do not pass electricity while providing the electrical interface 150, for example, silicon such as Si, SiO, SiO₂, silicon compound, metal such as CuW, ceramic such as Al₂O₃ and AlN, or a mixture thereof.

The optical waveguide 130 is disposed above the optical element 110, and is optically coupled to the optical element 110. The optical waveguide 130 is optically coupled to the optical element 110 while being spaced apart by a predetermined interval from a surface of the optical element 110 by the spacer 140.

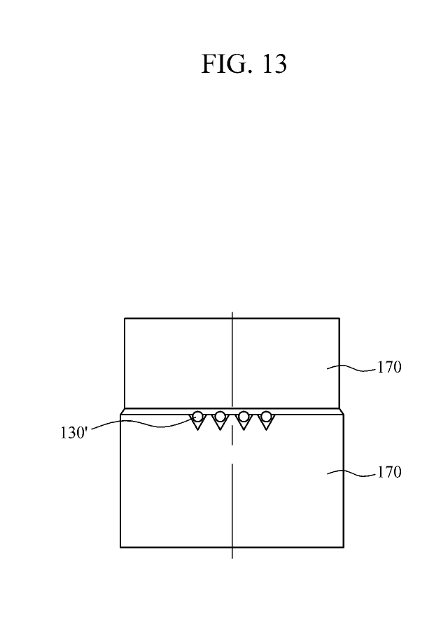

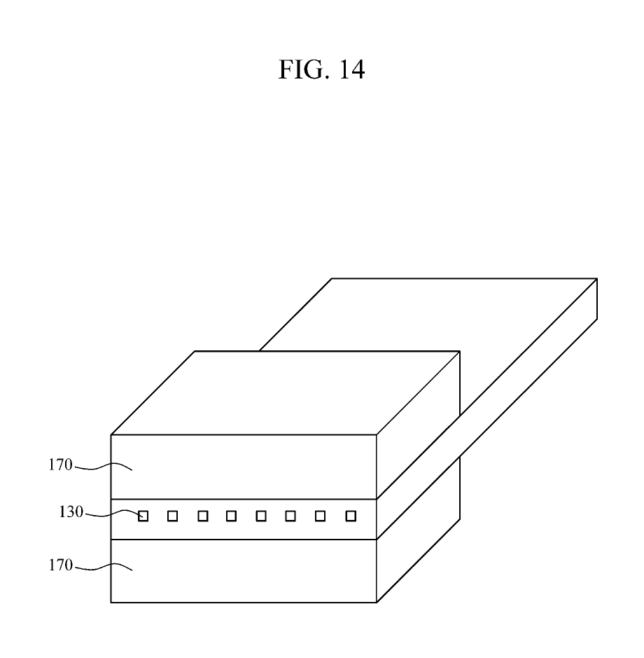

As an example, the optical waveguide 130 may be a single optical fiber, or may be an array of optical fibers. As shown in FIG. 13, optical fibers 130′ may be supportedly fixed between support blocks 170, so as to facilitate bonding the optical fibers 130′ with the spacer 140 later while preventing an optical axis from being misaligned after the manufacturing processing. As another example, the optical waveguide 130 may be a single optical waveguide or an array of optical waveguides. FIG. 14 is a schematic diagram illustrating the form of a planar light-wave circuit (PLC). If the optical waveguide is thin, the support block 170 may be fixed to one side of the optical waveguide 130 or the support blocks 170 may be fixed to the both sides of the optical waveguide 130 as shown in FIG. 14, so as to facilitate bonding between the optical waveguide 130 and the spacer 140 while preventing an optical axis from being misaligned after the manufacturing process.

The support block 170 may be fixed to one side or the support blocks 170 may be fixed to the both sides of the optical waveguide 130. If the optical waveguide 130 is thick enough, the support block 170 may not be used.

As described above, if the optical waveguide 130 and the spacer 140 bonded to each other are misaligned after the manufacturing process, the optical coupling efficiency is lowered. Accordingly, the bonding of the optical waveguide 130 and the spacer 140 may be performed using an adhesive causing little or no misalignment after the manufacturing process, or an adhesive having curing conditions causing small misalignment. Preferably, an UV epoxy may be used as an adhesive for bonding the optical waveguide 130 to the spacer 140. In addition, solder such as AgSn and AuSn, a solder alloy, or epoxy having curing conditions causing small misalignment may be used.

Meanwhile, the substrate 120 may be bonded to the spacer 140 while having small misalignment to some extent. Accordingly, solder such as AgSn and AuSn, a solder alloy, or epoxy that may cause misalignment during the curing process but ensuring superior adhesive force is used to bond the substrate 120 to the spacer 140.

The spacers 140 are formed to protrude at both sides of the substrate 120 such that an interval between the optical waveguide 130 and the optical element 110 is maintained.

The spacer 140 serves to maintain an interval D between the optical element 110 and the optical waveguide 130. The spacer 140 may be formed of various types of materials as long as it maintains the distance D between the optical element 110 and the optical waveguide 130. For example, silicon such as Si, SiO, SiO₂, glass, quartz, and silica, a silicon compound, a metal such as CuW, ceramic such as Al₂O₃ and AlN, or a mixture thereof may be used.

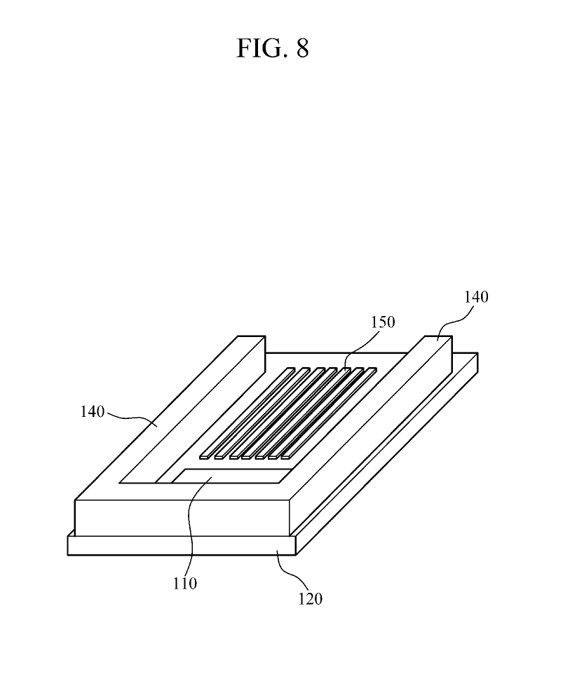

In addition, the spacer 140 may be provided in various shapes as long as it maintains the distance D between the optical element 110 and the optical waveguide 130. In detail, the spacer 140 may be provided at both sides while being parallel to each other in the form of a straight line as shown in FIG. 7, or the spacer 140 may be provided in the form of a letter ‘ [symbol] ’, ‘ [symbol] ’, or ‘ [symbol] ’ as shown in FIGS. 8 to 10. However, the shape of the spacer 140 is not limited thereto, and may be provided in various alternative examples.

According to an embodiment of the present disclosure, a surface of the optical waveguide which faces the optical element is treated with an antireflection (AR) coating.

When the optical element 110 is provided using a light source and light output from the light source returns to the light source due reflection or scattering at the optical waveguide 130, the characteristics of the light source may be changed. In order to prevent the characteristics of the light source from being changed, a coating layer 160 is formed by performing an antireflection (AR) coating on the surface of the optical waveguide 130.

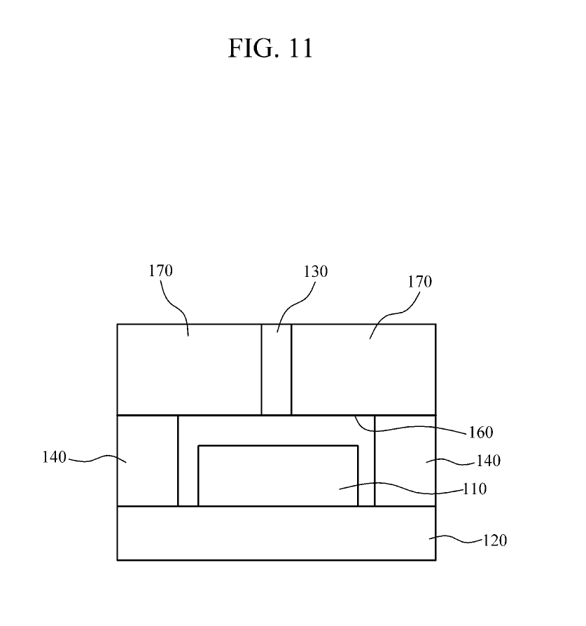

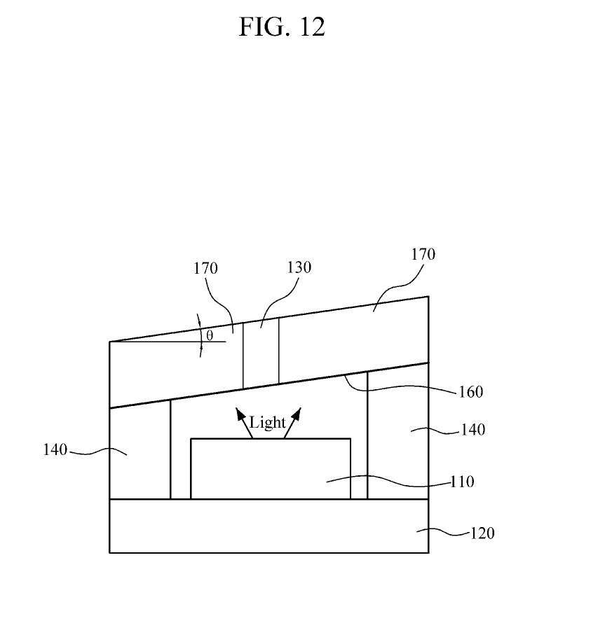

The optical waveguide 130 may be disposed in perpendicular to the surface of the light source as shown in FIG. 11. Meanwhile, referring to FIG. 12, an end section of the optical waveguide 130 which faces the optical element 110 may be angled to one side.

When the optical element 110 is provided using a light source and an optical axis of the optical element 110 is perpendicular to the end section of the optical waveguide 130, light output from the optical element 110 is reflected from the end section of the optical waveguide 130 and returns to the optical element 110. Accordingly, in order to prevent the light from returning to the optical element 110, the end section of the optical waveguide 130 may be provided to be inclined at a predetermined angle θ so as not to be perpendicular to the optical axis of the optical element 110.

If there is no chance or a little chance of light to be reflected at the optical waveguide 130, the surface of the optical waveguide 130 does not need to be AR coated, and the end section of the optical waveguide 130 may be provided to be perpendicular to the optical axis of the optical element 110. However, if there is a chance of light to be reflected at the optical waveguide 130, the surface of the optical waveguide 130 needs to be AR coated, and the end section of the optical waveguide 130 is provided to be inclined at the predetermined angle θ so as not to be perpendicular to the optical axis of the optical element 110.

When the support block 170 is formed according to an alternative example, lower ends of the support blocks 170 and upper ends of the spacers 140 making contact with the lower ends of the support blocks 170 as well as the optical waveguide 130 need to be inclined at the same angle.

According to the embodiment of the present disclosure, the substrate 120 includes a subsidiary substrate 121 on which the optical element 110 is mounted and a main substrate 122 on which the subsidiary substrate 121 and the spacer 140 are mounted.

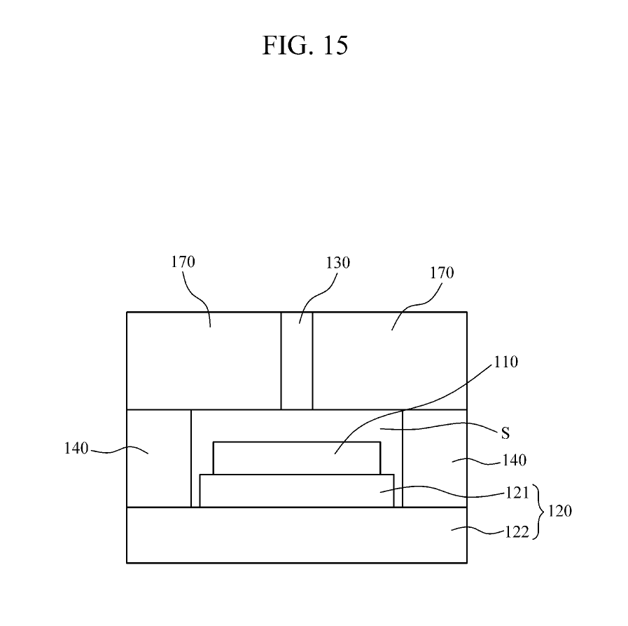

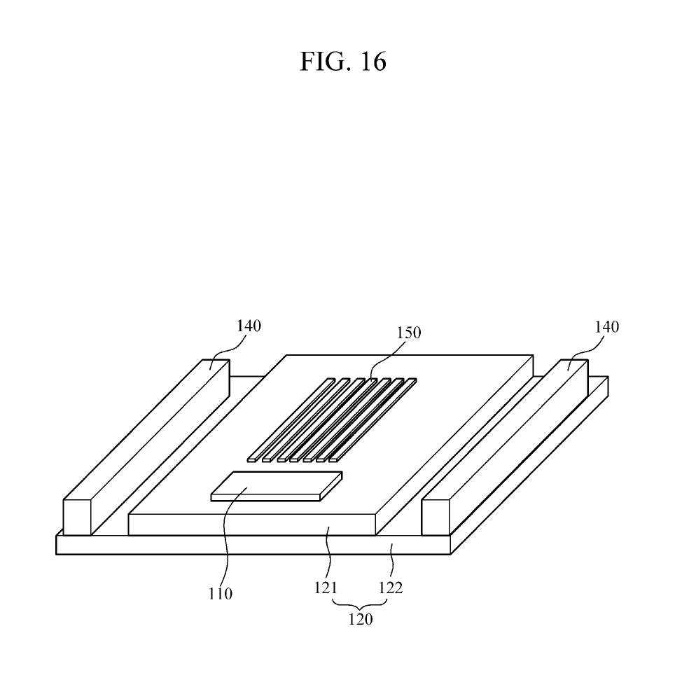

The subsidiary substrate 121 may be selectively used, and in order to adjust the interval between the optical element 110 and the optical waveguide 130, one or more subsidiary substrates 121 may be disposed between the optical element 110 and the main substrate 122 as shown in FIGS. 15 and 16.

When the subsidiary substrate 121 is provided as the above, the electrical interface 150 may be formed on one of the subsidiary substrate 121 and the main substrate 122, or both of the subsidiary substrate 121 and the main substrate 122.

As shown in FIGS. 15 and 16, the subsidiary substrate 121 serves to allow the optical element 110 to be fixed thereto and configured to provide the electrical interface 150. The subsidiary substrate 121 may be provided using a printed circuit board (PCB) or a flexible printed circuit board (FPCB) that provides the electrical interface 150. In addition, the subsidiary substrate 121 or the main substrate 122 may be provided using a material having a superior thermal conductivity to effectively emit heat generated from the optical element 110, thereby ensuring the performance of the optical element 110.

In more detail, the subsidiary substrate 121 may be formed using AlN providing the electrical interface 150 and ensuring a superior thermal conductivity, but the material of the subsidiary substrate 121 is not limited thereto and may be provided in various types of materials as long as it provides the electrical interface 150. For example, Si or ceramic may be used. Meanwhile, in order to ensure the performance of the optical element 110, the main substrate 122 may be provided using a material having a superior thermal conductivity, such as griffin, diamond, Au, Ag, Cu, CuW, AlN, Al₂O₃, Si, SiO, and SiO₂.

According to the embodiment of the present disclosure, a thermistor 180 is mounted on an upper surface of the substrate 120 to be adjacent to the optical element 110, and positioned to be lower than the optical element 110.

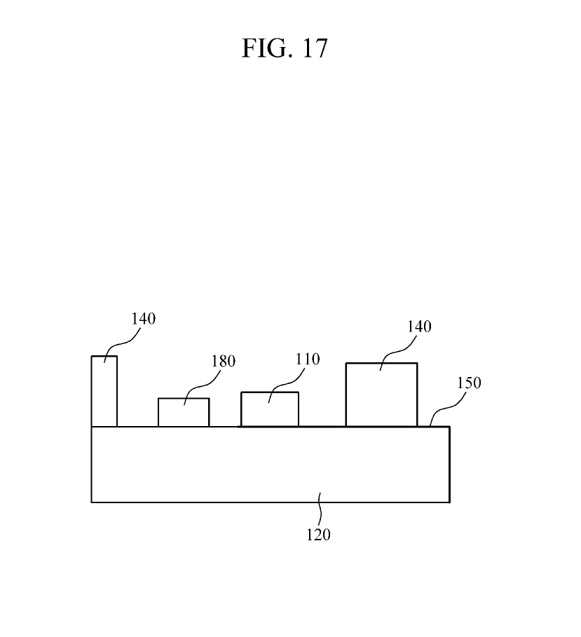

When the thermistor 180 has a height lower than that of the optical element 110 as shown in FIG. 17, the thermistor 180 and the optical element 110 may be formed on the same substrate 120. As an alternative example, when the substrate 120 includes the subsidiary substrate 121 and the main substrate 122, the thermistor 180 may be formed on the subsidiary substrate 121 together with the optical element.

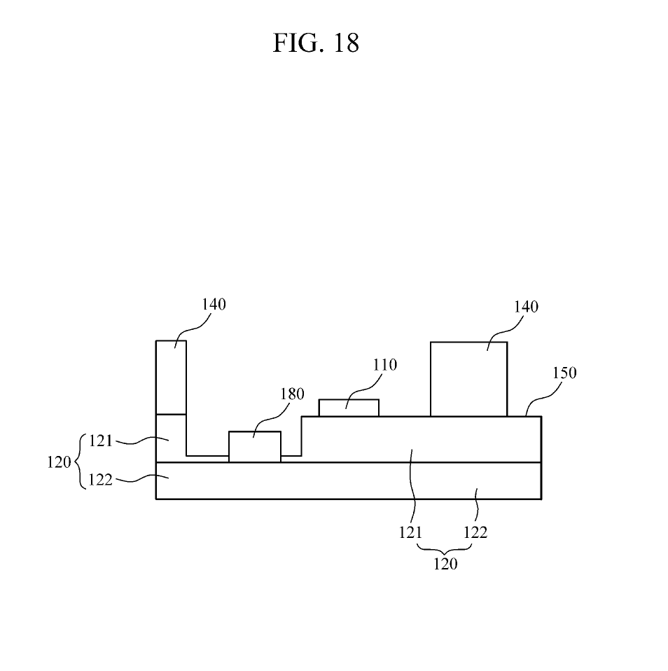

However, when the thermistor 180 has a height higher than that of the optical element 110, the interval between the optical element 110 and the optical waveguide 130 is increased, so that the optical coupling efficiency may be lowered. In this case, by placing the subsidiary substrate 121 between the optical element 110 and the main substrate 122, the distance between the optical element 110 and the optical waveguide 130 may be reduced as shown in FIG. 18.

According to an embodiment of the present disclosure, the substrate 120 may be integrally formed with the spacer 140.

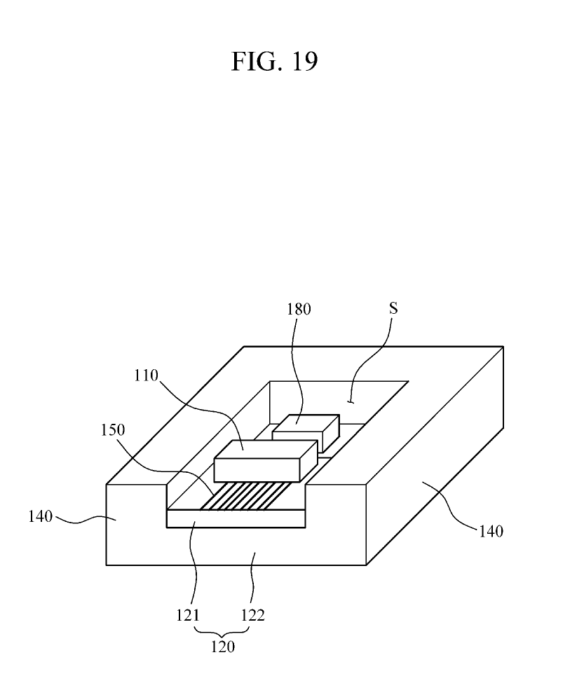

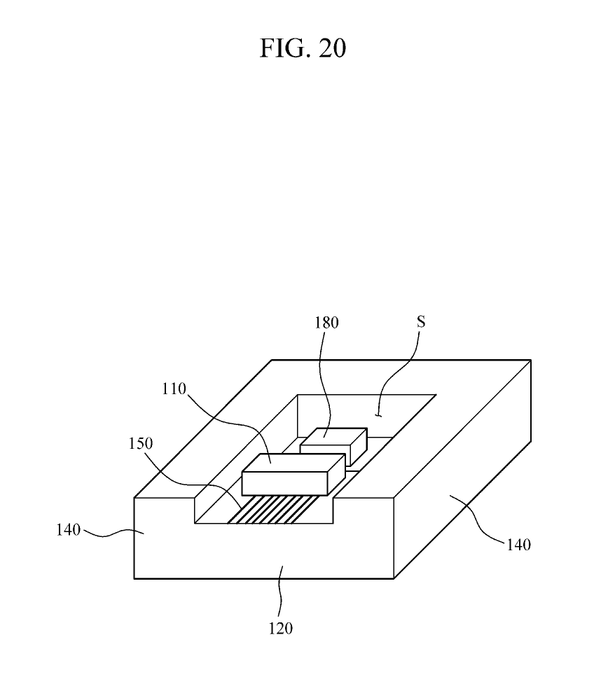

When the substrate 120 is integrally formed with the spacer 140 as shown in FIG. 19, the number of the manufacturing processes is reduced, thereby reducing the production cost. When the substrate 120 includes the subsidiary substrate 121 and the main substrate 122, the main substrate 122 may be integrally formed with the spacer 140 as shown in FIG. 20, and the subsidiary substrate 121 may be separately provided. Depending on situation, the main substrate 122, the spacer 140, and the subsidiary substrate 121 may be integrally formed with each other.

According to an embodiment of the present disclosure, the substrate 120 may be formed using an insulator. As an alternative example, when the substrate 120 includes the subsidiary substrate 121 and the main substrate 122, only the subsidiary substrate 121 may be formed using an insulator.

Meanwhile, when the substrate 120 is integrally formed with the spacer 140 as described above, the substrate 120 and the spacer 140 may be formed using an insulator that does not pass electricity. Preferably, the substrate 120 and the spacer 140 may be formed using a material having a superior thermal conductivity to effectively dissipate heat of the optical element 110. For example, the substrate 120 and the spacer 140 may be formed using a material having an insulating property and superior thermal conductivity, for example, silicon such as Si, SiO, and SiO₂, a silicon compound, and a ceramic-based material such as Al₂O₃ and AlN.

According to the cost-effective optical coupling module according to the present disclosure, the optical coupling of the optical element 110 and the optical waveguide 130 is achieved by only forming a predetermined space (S) between the optical element 110 and the optical waveguide 130 without disposing an expensive array lens between the optical element 110 and the optical waveguide 130, so that the optical packaging is simplified and a compact structure is provided, thereby producing the optical coupling module at a low cost. In addition, since the optical coupling is achieved at a minimum expense, the cost of the optical transmission sub-assembly or the optical reception sub-assembly is reduced. In addition, the performance of the optical element 110 measured in a state of a chip is maintained similar to the performance of the optical element 110 measured in a packaged state. In addition, as the array lens is not used, an expensive laser welder does not need to be used, so that the manufacturing equipment and the manufacturing process are simplified, thereby saving the production cost.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cost-effective optical coupling module comprising:
an optical element configured to output or receive an optical signal;
a substrate configured to allow the optical element to be fixed to an upper surface of one side thereof;
an optical waveguide disposed above the optical element and coupled to the optical element; and
spacers protruding at both sides of the substrate to maintain an interval between the optical waveguide and the optical element.

2. The cost-effective optical coupling module of claim 1, wherein an electrical interface is provided on an upper surface of the other side of the substrate.

3. The cost-effective optical coupling module of claim 1, wherein a surface of the optical waveguide which faces the optical element is treated with antireflection (AR) coating.

4. The cost-effective optical coupling module of claim 1, wherein an end section of the optical waveguide which faces the optical element is angled to one side.

5. The cost-effective optical coupling module of claim 1, wherein the optical waveguide is fixed to a support block so as to be easily bonded to the spacer.

6. The cost-effective optical coupling module of claim 1, wherein the substrate comprise:
a subsidiary substrate on which the optical element is mounted; and
a main substrate on which the subsidiary substrate and the spacer are mounted.

7. The cost-effective optical coupling module of claim 1, wherein a thermistor is mounted on an upper surface of the substrate to be adjacent to the optical element, the thermistor having a height lower than a height of the optical element.

8. The cost-effective optical coupling module of claim 1, wherein the substrate is integrally formed with the spacer.

9. The cost-effective optical coupling module of claim 6, wherein the main substrate is integrally formed with the spacer.

10. The cost-effective optical coupling module of claim 1, wherein the substrate is an insulator including silicon or ceramic.

11. The cost-effective optical coupling module of claim 6, wherein the subsidiary substrate is an insulator including silicon or ceramic.
